(19) United States
(12) Patent Application Publication
(10) Pub. No.: US 2009/0111672 A1
(43) Pub. Date: Apr. 30, 2009

(54) FOLD PROCESSING DEVICE, IMAGE FORMING APPARATUS, PRINT DIRECTING DEVICE, IMAGE FORMING SYSTEM, FOLD PROCESSING METHOD AND COMPUTER READABLE MEDIA STORING PROGRAM

(75) Inventors: Hideki Takahashi, Aikou-gun (JP); Masaya Kaji, Ebina-shi (JP); Yumiko Inomata, Ebina-shi (JP); Ayumi Ikegaya, Ebina-shi (JP); Takumasa Isobe, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/255,766

(22) Filed: Oct. 22, 2008

(30) Foreign Application Priority Data
Oct. 25, 2007 (JP) 2007-277123

(51) Int. Cl. B31B 49/00

(52) U.S. Cl. 493/37

(57) ABSTRACT

A fold processing device includes a setter that sets an area desired to be visible or an area desired to be hidden from outside in a state in which a paper sheet has been folded, a determining unit that determines folding conditions on the basis of a result of setting by the setter, and an executer that executes folding in accordance with the folding conditions determined by the determining unit.

### CROSS-REFERENCE TO RELATED APPLICATIONS

This application is based on and claims priority under 35 USC 119 from Japanese Patent Application No. 2007-277123 filed Oct. 25, 2007.

### BACKGROUND

### Technical Field

The present invention relates to a fold processing device, an image forming apparatus, a print directing device, an image forming system, a fold processing method and computer readable media storing program.

### SUMMARY

According to an aspect of the invention, there is provided a fold processing device including: a setter that sets an area desired to be visible or an area desired to be hidden from outside in a state in which a paper sheet has been folded, a determining unit that determines folding conditions on the basis of a result of setting by the setter, and an executer that executes folding in accordance with the folding conditions determined by the determining unit.

### BRIEF DESCRIPTION OF THE DRAWINGS

Exemplary embodiments of the present invention will be described in detail based on the following figures, wherein:

FIG. 1 shows an image forming system, which is a first exemplary embodiment of the present invention;

FIG. 2 shows the hardware configuration of an image forming apparatus 10 in the first exemplary embodiment of the invention;

FIG. 3 shows the functional configuration of the image forming apparatus 10 in the first exemplary embodiment of the invention;

FIG. 4 shows a specific folding mechanism for realizing a folding executer 21 in FIG. 3;

FIG. 5 illustrates a double folding action by the folding executer 21;

FIG. 6 illustrates a further double folding action by the folding executer 21;

FIG. 7 illustrates a Z-folding action by the folding executer 21;

FIG. 8 illustrates a further Z-folding by the folding executer 21;

FIG. 9 is a flow chart of folding in the image forming system of the first exemplary embodiment of the invention;

FIG. 10 shows an example of screen displayed when an area is set by an area setter 33;

FIG. 11 shows another example of screen displayed when an area is set by the area setter 33;

FIG. 12 shows still another example of screen displayed when an area is set by the area setter 33;

FIG. 13 shows an example of screen displayed when the user sets an area while watching the preview image of the result of folding an area is set;

FIG. 14 shows another example of screen displayed when the user sets an area while watching the preview image of the result of folding;

FIG. 15 shows still another example of screen displayed when the user sets an area while watching the preview image of the result of folding;

FIG. 16 shows still another example of screen displayed when the user sets an area while watching the preview image of the result of folding;

FIG. 17 shows still another example of screen displayed when the user sets an area while watching the preview image of the result of folding;

FIG. 18 shows still another example of screen displayed when the user sets an area while watching the preview image of the result of folding;

FIG. 19 is a block diagram showing the configuration of a fold processing device 20a, which is a second exemplary embodiment of the invention;

FIG. 20 is a block diagram showing the configuration of an image forming system, which is a third exemplary embodiment of the invention; and

FIG. 21 is a block diagram showing the configuration of an image forming apparatus 10c, which is a fourth exemplary embodiment of the invention.

### DETAILED DESCRIPTION

Next, exemplary embodiments of the present invention will be described in detail below with reference to accompanying drawings.

### First Exemplary Embodiment

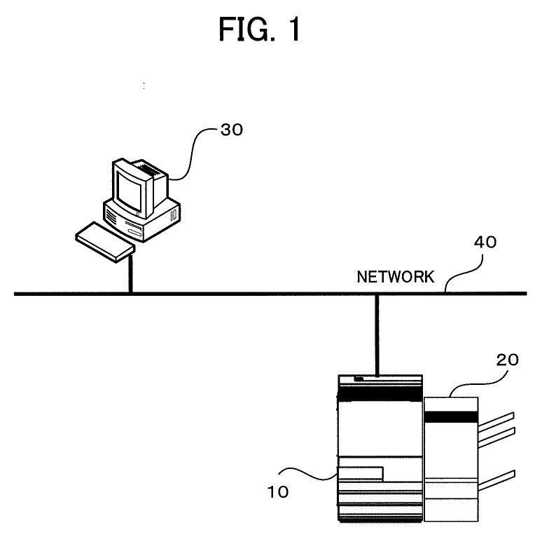

FIG. 1 shows an image forming system, which is a first exemplary embodiment of the invention.

The image forming system of this exemplary embodiment includes an image forming apparatus 10, a fold processing device 20 and a terminal 30 connected to each other by a network 40 as shown in FIG. 1. The terminal 30 functions as a print directing device which generates print data and transmits it to the image forming apparatus 10 via the network 40. The image forming apparatus 10 accepts the print data transmitted from the terminal 30 and outputs an image matching the print data onto a paper sheet. The fold processing device 20 folds the paper sheet outputted from the image forming apparatus 10. Incidentally, the image forming apparatus 10 is a so-called multifunction printer having plural functions including a printing function, scanning function, copying function and facsimile function.

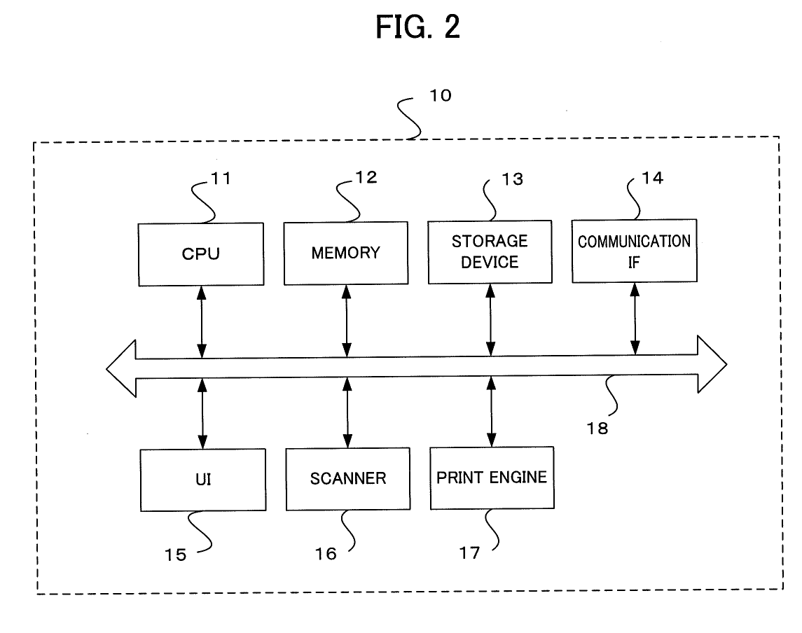

Next, the hardware configuration of the image forming apparatus 10 in the image forming system of this exemplary embodiment is shown in FIG. 2.

The image forming apparatus 10, as shown in FIG. 2, has a CPU 11, a memory 12, a storage device 13 such as a hard disk drive (HDD), a communication interface (IF) 14 which transmits and receives data to and from external units or the like via the network 40, a user interface (UI) 15 including a touch panel or a liquid crystal display and a keyboard, a scanner 16 and a print engine 17. These constituent elements are connected to one another via a control bus 18.

The CPU 11 controls the operation of the image forming apparatus 10 by executing prescribed processing in accordance with a control program stored in the memory 12 or the storage device 13.

Incidentally, though it is described above that the CPU 11 reads out the control program stored in the memory 12 or the storage device 13 and executes it in this exemplary embodiment, it is also possible to store the program in a storage medium such as a CD-ROM or the like and provide it to the CPU 11.

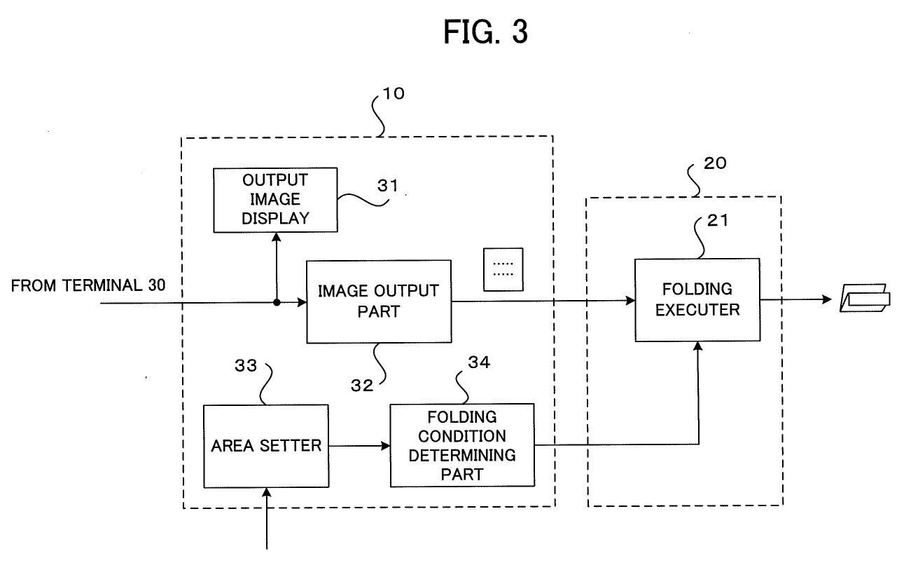

FIG. 3 is a block diagram showing the configuration of functions of the image forming apparatus 10 and the fold processing device 20 realized by the execution of the control program.

The image forming apparatus 10 of this exemplary embodiment, as shown in FIG. 3, has an output image display 31, an image output part 32, an area setter 33 and a folding condition determining part 34. Further, the fold processing device 20 has a folding executer 21.

The output image display 31 displays on a display device a preview image, which is the output image which would result from the printing of print data transmitted from the terminal 30.

The image output part 32 outputs to a paper sheet to be folded by the fold processing device 20 an image based on the print data transmitted from the terminal 30.

The area setter 33 sets an area desired to be visible or an area desired to be hidden from outside in the state in which the paper sheet has been folded. Here, the area desired to be visible from outside means an area whose contents would be visible from outside even in the state of having been folded, for instance an area which, as a result of folding, would be visible from outside by appearing on the surface. The area desired to be hidden means an area whose contents are desired to be invisible from outside, for instance an area which would be made invisible from outside by being positioned inside by the folding. When an area desired to be visible from outside has been set by the area setter 33, the remaining area is an area which is desired to be hidden, and when an area desired to be hidden has been set by the area setter 33, the remaining area is an area which is desired to be visible from outside.

The folding condition determining part 34 determines the folding conditions including the set folding position, folding direction and folding sequence based on the result of setting by the area setter 33.

The output image display 31 also displays a preview image, which is the folded state resulting from folding in accordance with the folding conditions determined by the folding condition determining part 34.

The folding condition determining part 34 also has the function of a corrector to correct the folding conditions determined by the folding condition determining part 34 in accordance with a correcting instruction accepted via the UI 15 from the user having referenced the preview display on the output image display 31.

The folding executer 21 receives from the image forming apparatus 10 the folding conditions determined by the folding condition determining part 34, and executes folding on the paper sheet on which an image has been formed by the image forming apparatus 10.

In the image forming system of this exemplary embodiment, it is possible to fold a variety of paper sheets including those on which printing or copying has been done by the image forming apparatus 10.

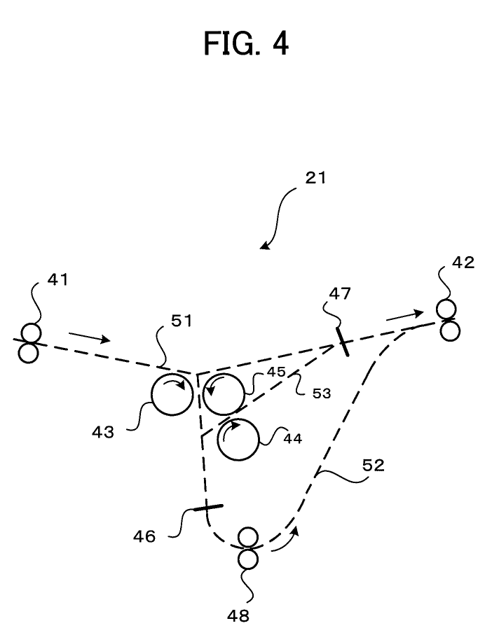

Next, a specific folding mechanism for realizing the folding executer 21 is shown in FIG. 4.

The folding executer 21, as shown in FIG. 4, is provided with take-up rollers 41, ejecting rollers 42, folding rollers 43 through 45, a Z-folding stopper 46, a double folding stopper 47, double folding paper sheet carrying rollers 48, a folding part main channel 51 disposed between the take-up rollers 41 and the ejecting rollers 42, a double folding channel 52 for letting double-folded paper sheets be carried, and a Z-folding channel 53 for letting Z-folded paper sheets be carried.

The double folding stopper 47 disposed midway on the folding part main channel 51, when double folding and Z-folding are to be accomplished, stops the paper sheets carried along the folding part channel 51. The Z-folding stopper 46 disposed midway on the double folding channel 52, when Z-folding is to be accomplished, stops the paper sheets carried along the double folding channel 52. The positions of the double folding stopper 47 and the Z-folding stopper 46 are variable according to the position or positions of folding, and folding can be accomplished in the desired position or positions by varying the positions of the double folding stopper 47 and the Z-folding stopper 46.

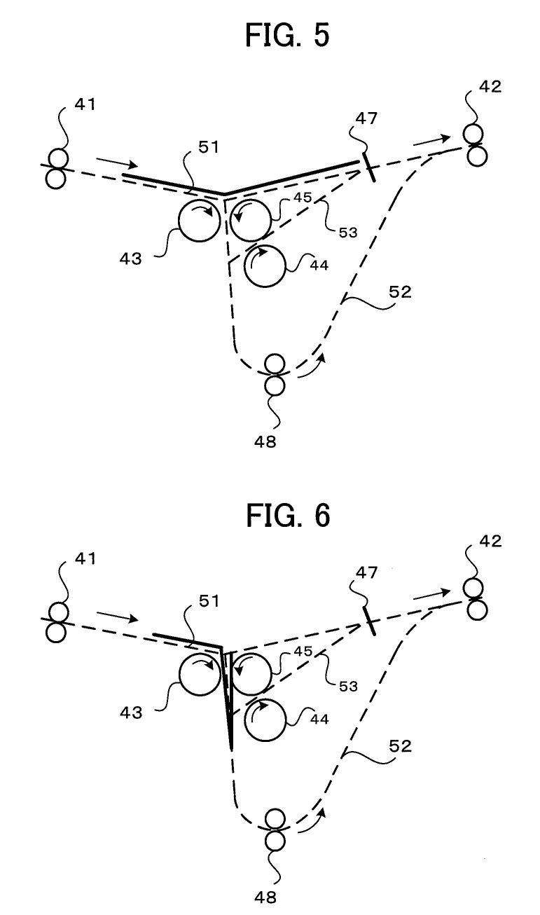

The folding action by the folding executer 21 configured in this way will be described below with reference to FIG. 5 through FIG. 8.

First, double folding of paper sheets will be described. When double folding is to be accomplished, as the double folding stopper 47 blocks the folding part main channel 51, the front end of a paper sheet carried along the folding part main channel 51 is stopped by the double folding stopper 47 as shown in FIG. 5. The paper sheet stopped by the double folding stopper 47 is pulled in a manner of being forced in by the folding rollers 43 and 45 as shown in FIG. 6 and double-folded. The paper sheet double-folded in this way is carried by the double folding paper sheet carrying rollers 48 along the double folding channel 52, which joins the folding part main channel 51, and discharged by the ejecting rollers 42 out of the folding executer 21.

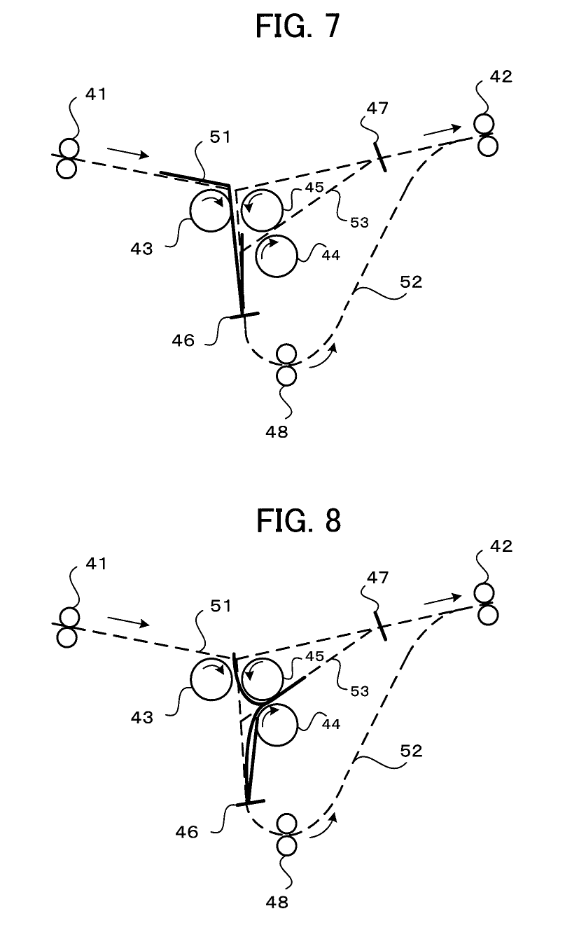

Next, Z-folding of paper sheets will be described. When Z-folding is to be accomplished, the Z-folding stopper 46 is closed in addition to the double folding stopper 47. Where Z-folding is to be accomplished, first, double folding is done in a similar process to that illustrated in FIG. 5 and FIG. 6. Then, when Z-folding as such is to be done, as the Z-folding stopper 46 is blocked, the paper sheet pulled into the double folding channel 52 is stopped by the Z-folding stopper 46 as shown in FIG. 7. The paper sheet stopped by the Z-folding stopper 46 is Z-folded pulled in a manner of being forced in by the folding rollers 44 and 45 as shown in FIG. 8. The paper sheet Z-folded in this way is carried by the Z-folding channel 53, which joins the folding part main channel 51, and discharged by the ejecting rollers 42 out of the folding executer 21.

Thus in the folding executer 21, folding can be executed in accordance with the folding conditions determined by the folding condition determining part 34 by varying the positions of the double folding stopper 47 and the Z-folding stopper 46 as described above.

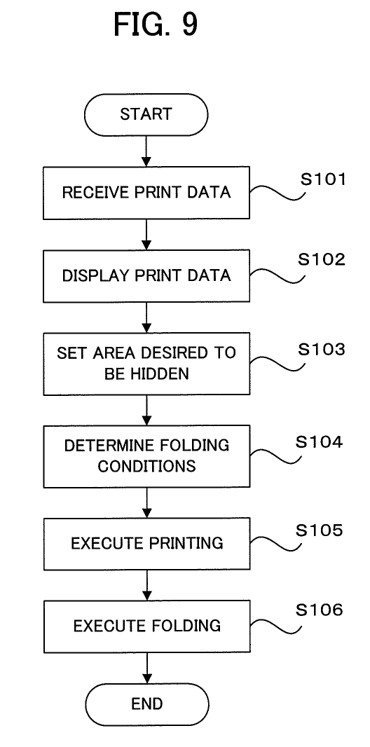

Next, folding processed in the image forming system of this exemplary embodiment will be described with reference to the flow chart of FIG. 9.

Print data is generated at the terminal 30 and, when this print data is transferred to the image forming apparatus 10, the image forming apparatus 10 receives this print data (step S101). Then, the output image display 31 of the image forming apparatus 10 displays an image based on the received print data on the display or the like (step S102). When the user looks at this display and sets with the area setter 33 an area desired to be hidden from outside or an area desired to be visible from outside (step S103), the folding condition determining part 34 sets the folding conditions which would realize the result of setting in the area setter 33 including the direction, position and sequence of folding (step S104). Then, the folding conditions set by the folding condition determining part 34 are transferred from the image forming apparatus 10 to the fold processing device 20.

The image output part 32 of the image forming apparatus 10 outputs to a paper sheet an image based on print data from the terminal 30 (step S105). The folding executer 21 of the fold processing device 20 executes folding of the paper sheet outputted from the image forming apparatus 10 in accordance with the folding conditions set by the folding condition determining part 34 (step S106).

Now, specific examples of determination of the folding conditions by the folding condition determining part 34 on the basis of the area set by the area setter 33 will be described with reference to drawings.

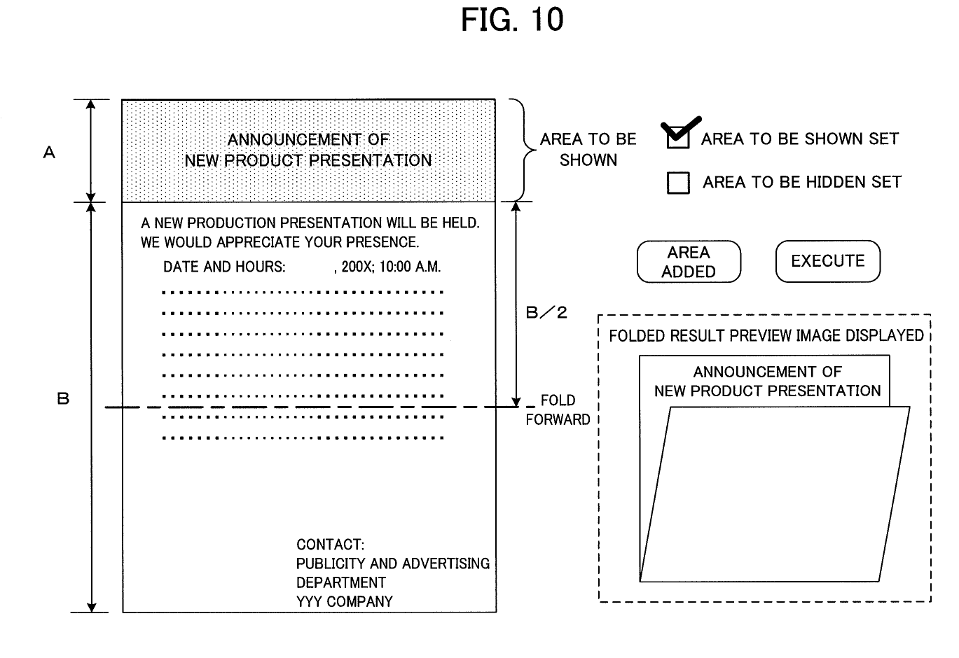

FIG. 10 shows an example of screen displayed when an area is set by the area setter 33. This FIG. 10 shows an example of display when the area to be shown is set in the header part at the front end of a paper sheet. In the example shown in FIG. 10, a part of length A from the front end of the paper sheet is set as the area to be shown.

When an area that is intended to show only a prescribed length from the front end of a paper sheet is set as in this example, the folding condition determining part 34 determines such folding conditions that the paper sheet is folded forward on the line representing the addition of the length (A) of the paper sheet to a half of the value (B) which is the balance of subtraction of the length of the area to be shown from the total length of the paper sheet from the front end of the paper sheet in the direction of its carriage. More specifically, the folding condition determining part 34 determines such folding conditions as require forward folding in a position at a distance of A+B/2 from the front end of the paper sheet. By folding forward the paper sheet in this position of A+B/2 from the front end of the paper sheet, the area desired to be shown is made visible from outside while keeping the other area hidden from outside.

When a set of folding conditions is determined by the folding condition determining part 34 of this exemplary embodiment, though the folding position is set where the length (A) of the paper sheet is added to a half of the value (B) which is the balance of subtraction of the length of the area to be shown from the total length of the paper sheet, it is not always important to add strictly a half of the value (B) in determining the folding position. It is obviously sufficient, if an area desired to be shown is set, for the area to be visible or, if an area desired to be hidden is set, for the area to be invisible.

In the example of display shown in FIG. 10, the state of the paper sheet folded in accordance with the folding conditions so set is displayed as the folded result preview image.

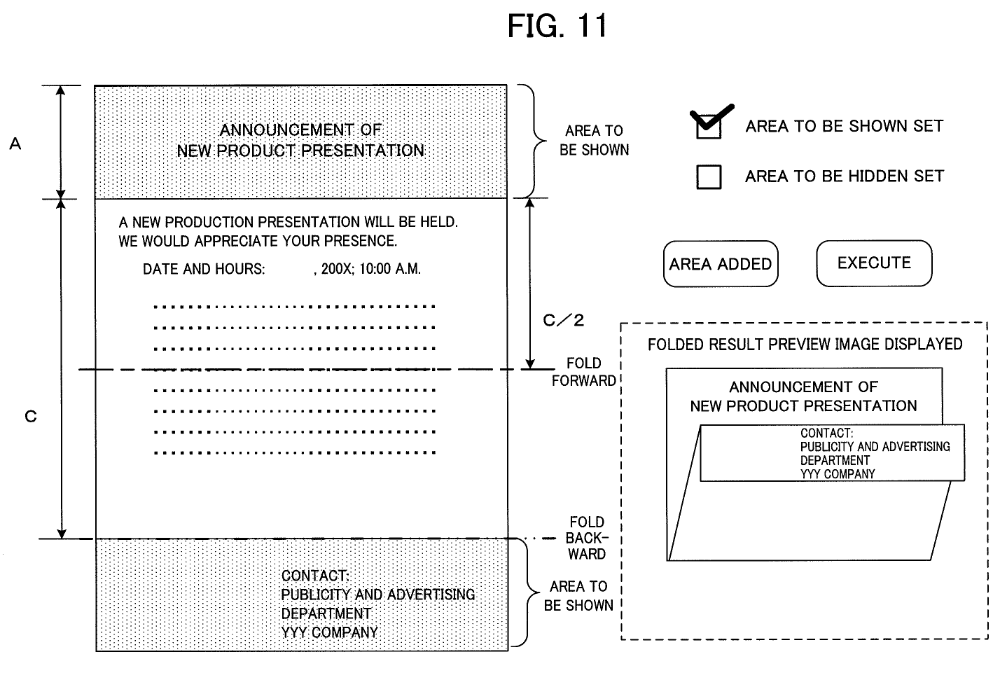

In the image forming apparatus 10 of this exemplary embodiment, more than one area desired to be shown can be set in different positions. FIG. 11 shows an example of display in which two areas desired to be shown, one in the header part toward the front end and the other in the footer part toward the rear end of a paper sheet, are to be set. In the example shown in FIG. 11, the part of the length A from the front end of the paper sheet is set as an area desired to be shown and the part behind the length A+C from the front end of the paper sheet is also set as another area desired to be shown.

When an area of a prescribed length from the front end of a paper sheet and another area of a prescribed length from the rear end of the paper sheet are set in this way, the folding condition determining part 34 determines such folding conditions as require forward folding in a position representing the addition of the length (A) of the area to be shown in the header part to a half of the value (C) which is the balance of subtraction of the length of the area to be shown in the header part and that in the footer part from the total length of the paper sheet from the front end of the paper sheet in the direction of its carriage and backward folding in a position representing the value (A+C) which is the balance of subtraction of the length A+C from the area to be shown in the footer part from the total length of the paper sheet in the direction of its carriage. More specifically, the folding condition determining part 34 determines such folding conditions as require forward folding in the position of A+C/2 and backward folding in the position of A+C from the front end. Then, the state of the paper sheet folded in accordance with the folding conditions so set is displayed as the folded result preview image.

Although the foregoing description referred to a case in which, in each instance of determination of the folding conditions by the folding condition determining part 34 in this exemplary embodiment, a half of each given value is calculated and added or subtracted in figuring out and determining the folding position, it is not always important to add or subtract strictly a half of each value. It is obviously sufficient, if an area desired to be shown is set, for the area to be visible or, if an area desired to be hidden is set, for the area to be invisible.

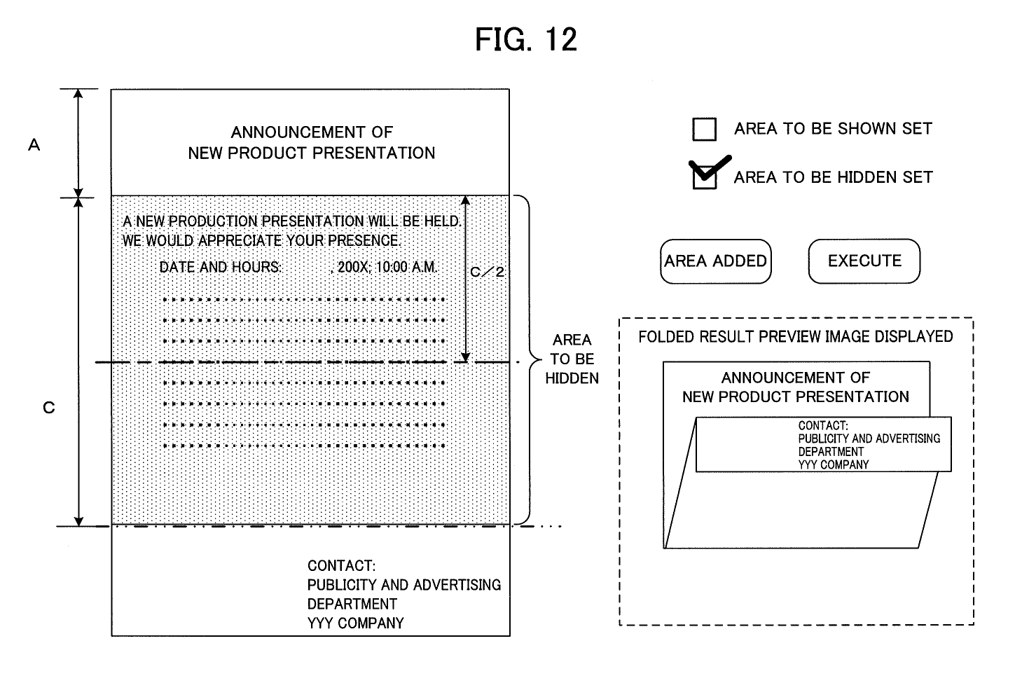

FIG. 12 is an example of display when an area desired to be hidden is to be set. What is shown in FIG. 12 is a case, where similar setting to FIG. 11 is wanted, an area desired to be hidden from outside is set instead of an area desired to be shown. In such a case of setting, too, the folding conditions similar to those shown in FIG. 11 are determined by the folding condition determining part 34, because where an area desired to be visible from outside is set by the area setter 33, the remaining area is desired to be hidden, and where an area desired to be hidden is set by the area setter 33, the remaining area is desired to be visible from outside.

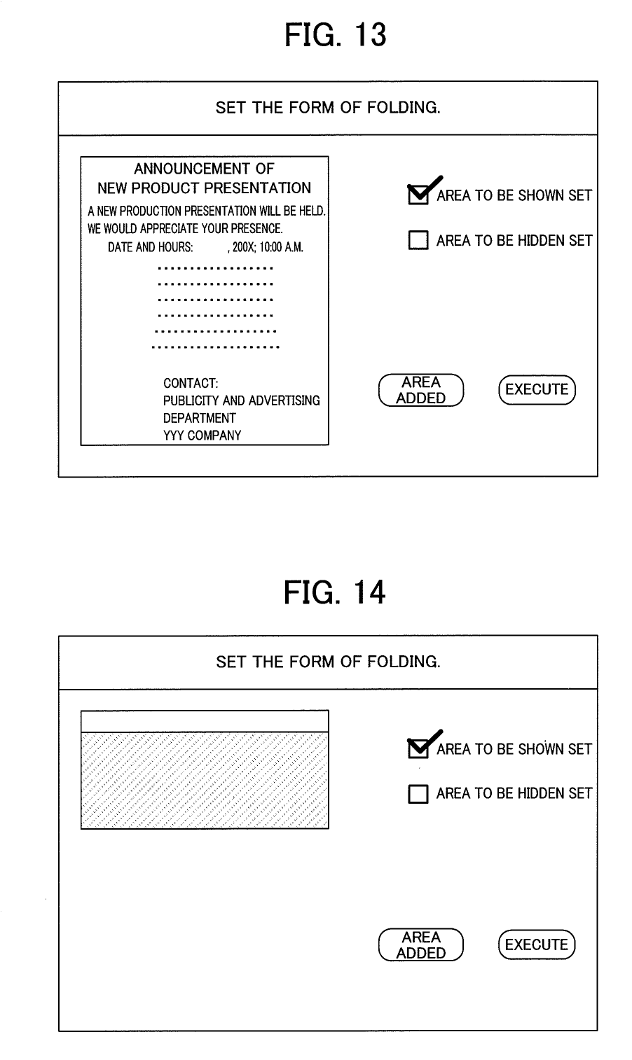

Next, examples of display in a case where the user sets the area desired to be shown or the area desired to be hidden while watching the preview image of the result of folding will be described with reference to FIG. 13 through FIG. 18.

When area setting is to be done by this method, it is selected whether an area desired to be shown is to be set or an area desired to be hidden is to be set in a state in which the image of the paper sheet to be folded is displayed as shown in FIG. 13. In the case described below, it is supposed that an area desired to be shown has been selected.

Where setting of an area desired to be shown has been selected as in this case, an image in which all the areas are hidden as a result of double folding is displayed as shown in FIG. 14.

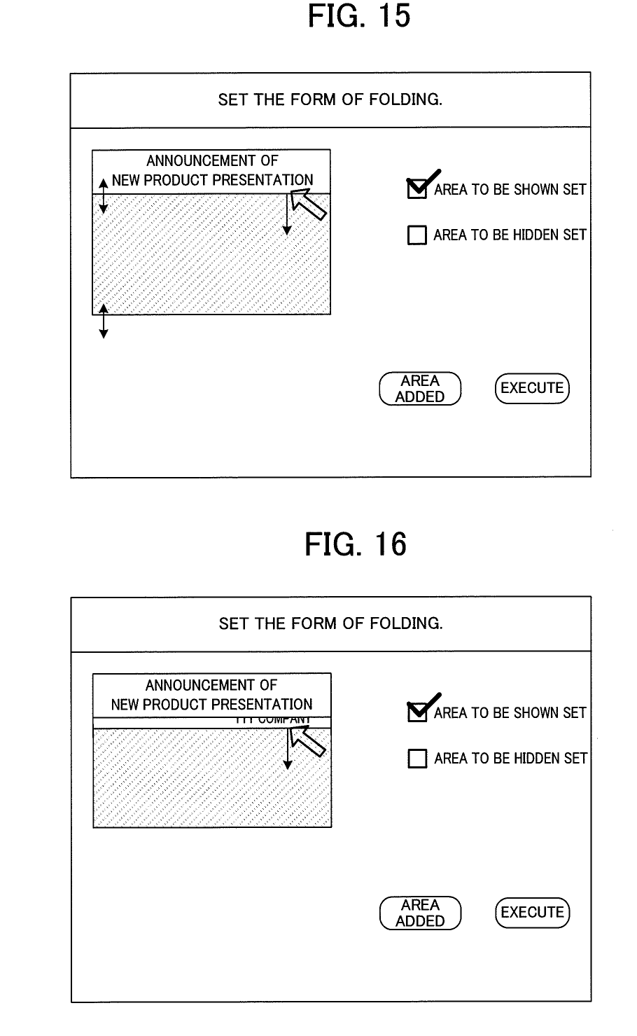

The user who sets an area adjusts the position of the folded lower end of the paper sheet by dragging while checking on the screen the area desired to be made visible as shown in FIG. 15. When the user presses down the execution button after completing this adjustment, the extent of the area desired to be shown is finalized.

If the user then presses the area addition button, a new area desired to be shown is added to the bottom end part of the paper sheet as shown in FIG. 16.

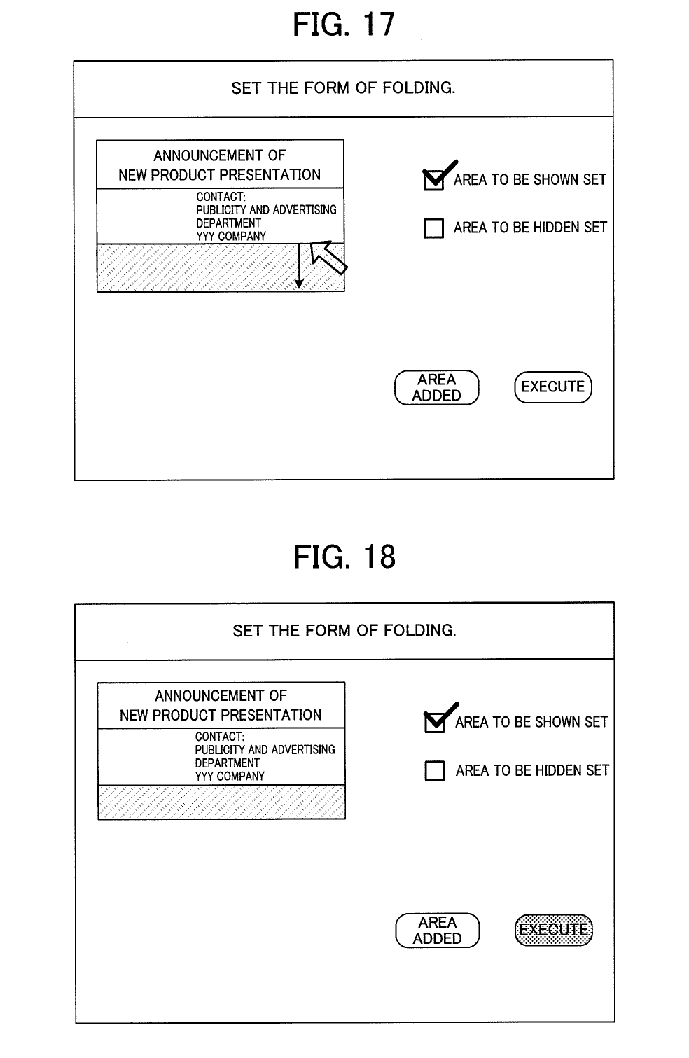

Then, as shown in FIG. 17, the user adjusts the position of the folded lower end of the paper sheet by dragging while checking on the screen the area desired to be shown. When, as shown in FIG. 18, the user presses down the execution button after completing this adjustment, the extent of the area desired to be shown is finalized. Even when the extent of the area desired to be shown toward the lower end of the paper sheet is adjusted, the earlier set extent of the area desired to be shown toward the lower end of the paper sheet is not changed. However, even on the screen shown in FIG. 17, the earlier set extent of the area desired to be shown toward the lower end of the paper sheet may as well be made adjustable when the upper side of that area is dragged.

It is further conceivable to display on the screen, after the folding conditions have been finalized, an expansion plan showing where a fold will be made when the set folding conditions are executed.

### Second Exemplary Embodiment

Next, a fold processing device 20a, which is a second exemplary embodiment of the invention, will be described.

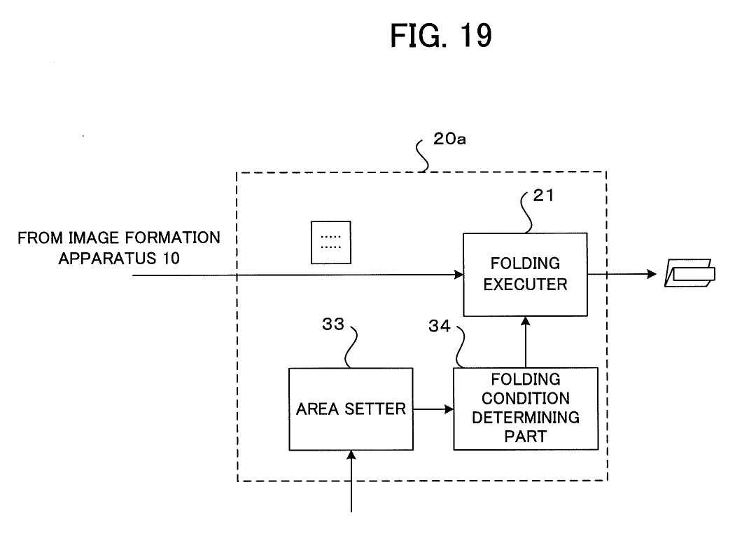

The fold processing device 20a in this exemplary embodiment has a folding executer 21, an area setter 33 and a folding condition determining part 34 as shown in FIG. 19. In FIG. 19, the same constituent elements as their counterparts in FIG. 3 are denoted respectively by the same reference signs, and their description will be dispensed with.

The fold processing device 20a of this exemplary embodiment is provided with the area setter 33 and the folding condition determining part 34 in the counterpart of the fold processing device 20 in the image forming system of the first exemplary embodiment shown in FIG. 3.

This configuration enables the fold processing device 20a by itself in this exemplary embodiment to set the area desired to be shown or the area to be hidden and to determine the folding conditions.

### Third Exemplary Embodiment

Next, an image forming system, which is a third exemplary embodiment of the invention, will be described.

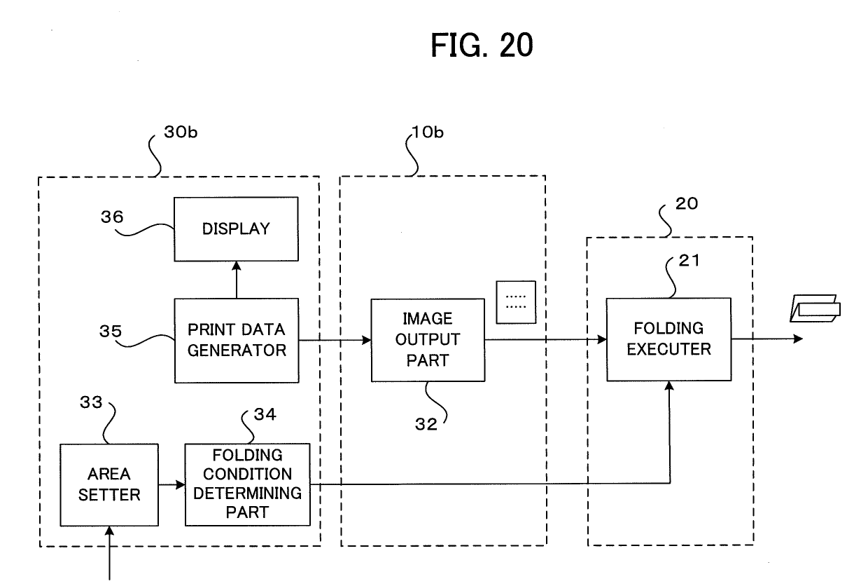

The image forming system in this exemplary embodiment, as shown in FIG. 20, includes a terminal 30b, an image forming apparatus 10b and a fold processing device 20. In FIG. 20, the same constituent elements as their counterparts in FIG. 3 are denoted respectively by the same reference signs, and their description will be dispensed with.

The terminal 30b in this exemplary embodiment is provided with the area setter 33, the folding condition determining part 34, a print data generator 35 and a display 36. Further, the image forming apparatus 10b has an image output part 32.

The print data generator 35 generates print data to be transmitted to the image forming apparatus 10b. The display 36 displays an image based on the print data generated by the print data generator 35.

The terminal 30b in this exemplary embodiment, functioning as a print directing device which directs printing by the image forming apparatus 10b, also has a function to set the area desired to be shown or the area to be hidden after the folding and to determine the folding conditions. The folding conditions determined by the folding condition determining part 34 may be transferred either via the image forming apparatus 10b or directly to the fold processing device 20.

### Fourth Exemplary Embodiment

Next, an image forming system, which is an image forming apparatus, which is a fourth exemplary embodiment, will be described.

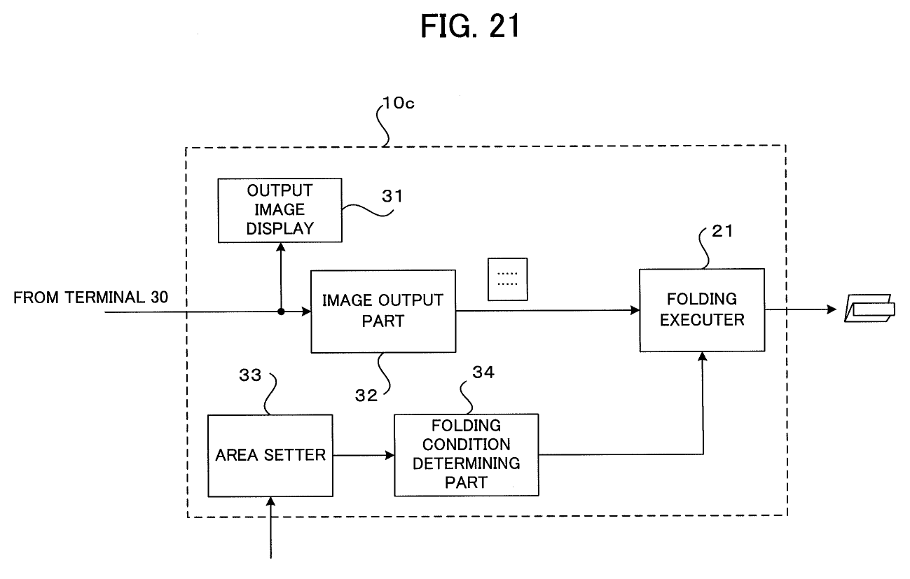

An image forming apparatus 10c in this exemplary embodiment, as shown in FIG. 21, has a configuration in which a folding executer 21 is provided in the image forming apparatus 10 of the first exemplary embodiment shown in FIG. 3. In FIG. 21, the same constituent elements as their counterparts in FIG. 3 are denoted respectively by the same reference signs, and their description will be dispensed with. The image forming apparatus 10c of this exemplary embodiment represents application of the invention to an image forming apparatus provided with a folding mechanism.

In this exemplary embodiment, the image forming apparatus 10c by itself accomplishes setting of the area desired to be shown or the area to be hidden, determination of the folding conditions and execution of folding.

### [Modifications]

Although the foregoing description of the exemplary embodiments refers to the application of the invention to double folding in which paper sheets are folded forward in their middle and Z-folding in which paper sheets are folded forward and then backward in their middle, the invention is not limited to such applications, but can be similarly applied to obtain the area to be shown or the area to be hidden by any other folding method.

Although the foregoing description of this exemplary embodiment refers to an image forming system including the fold processing device 20 having a folding function, the invention can be similarly applied to an image forming system using a post-processor having other functions, such as stapling, book binding and punching functions, in addition to the folding function.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fold processing device comprising:
a setter that sets an area desired to be visible or an area desired to be hidden from outside in a state in which a paper sheet has been folded,
a determining unit that determines folding conditions on the basis of a result of setting by the setter, and
an executer that executes folding in accordance with the folding conditions determined by the determining unit.

2. The fold processing device according to claim 1, further having a display that displays a folded state resulting from folding in accordance with the folding conditions determined by the determining unit.

3. The fold processing device according to claim 2, further having a corrector that corrects, in accordance with an accepted correcting instruction, the folding conditions determined by the determining unit.

4. The fold processing device according to claim 1, wherein the determining unit, when an area that is intended to show only a prescribed length from the front end of a paper sheet is set, determines such folding conditions that the paper sheet is folded forward in a position representing addition of a length of the area desired to be shown to a half of the value which is the balance of subtraction of a length of the area desired to be shown from a total length of the paper sheet from a front end of the paper sheet in the direction of the carriage thereof.

5. The fold processing device according to claim 1, wherein the determining unit, when an area that is intended to show a first length from the front end of a paper sheet and another area that is intended to show a second length from the rear end of the paper sheet are set, determines such folding conditions as require forward folding in a position representing the addition of the first length to a half of the value which is the balance of subtraction of the first length and the second length from the total length of the paper sheet in the direction of the carriage thereof and backward folding in a position representing the subtraction of the second length from the total length of the paper sheet in the direction of the carriage thereof, both measured from the front end of the paper sheet.

6. An image forming apparatus comprising:
a setter that sets an area desired to be visible or an area desired to be hidden from outside in a state in which a paper sheet has been folded,
a determining unit that determines folding conditions on the basis of a result of setting by the setter, and
an output unit that outputs an image to the paper sheet to be folded.

7. A print directing device comprising:
a setter that sets an area desired to be visible or an area desired to be hidden from outside in a state in which a paper sheet has been folded, and
a determining unit that determines folding conditions on the basis of a result of setting by the setter.

8. An image forming system comprising:
a setter that sets an area desired to be visible or an area desired to be hidden from outside in a state in which a paper sheet has been folded,
a determining unit that determines folding conditions on the basis of a result of setting by the setter,
an output unit that outputs an image to the paper sheet to be folded, and
an executer that subjects the paper sheet to which an image has been outputted by the output unit to folding in accordance with the folding conditions determined by the determining unit.

9. A computer readable medium storing a program for causing a computer to execute a process comprising:
setting an area desired to be visible or an area desired to be hidden from outside in a state in which a paper sheet has been folded,
determining folding conditions on the basis of a result of the setting, and
executing folding in accordance with the determined folding conditions.

10. A computer readable medium storing a program for causing a computer to execute a process comprising:
setting an area desired to be visible or an area desired to be hidden from outside in a state in which a paper sheet has been folded, and
determining folding conditions on the basis of a result of the setting.

11. A fold processing method comprising:
setting an area desired to be visible or an area desired to be hidden from outside in a state in which a paper sheet has been folded,
determining folding conditions on the basis of a result of the setting, and
executing folding in accordance with the determined folding conditions.
